(19) United States
(12) Patent Application Publication
(10) Pub. No.: US 2008/0264387 A1
(43) Pub. Date: Oct. 30, 2008

(54) Method and System for Adjusting Engine Fuel Rates by Adjusting Fuel Pressure

(76) Inventor: Paul Spivak, Mayfield Heights, OH (US)

Correspondence Address: PATENT, COPYRIGHT & TRADEMARK LAW GROUP, 4199 Kinross Lakes Parkway, Suite 275, RICHFIELD, OH, 44286, US

(21) Appl. No.: 12/109,993

(22) Filed: Apr. 25, 2008

Related U.S. Application Data
(60) Provisional application No. 60/914,454, filed on Apr. 27, 2007.

(51) Int. Cl. F02M 69/54

(52) U.S. Cl. 123/457

(57) ABSTRACT

A fuel pump configured to provide a fuel to a fuel injector component at a first fuel pressure, and thereby to provide the fuel to the fuel injector component at a first fuel rate. A secondary fuel pump interposed between the fuel pump and the injector component is in circuit communication with a switch such that the secondary fuel pump increases or decreases the fuel pressure in response to an operation of the switch to provide the fuel to the fuel injector component at a modified second fuel pressure, which is greater than the first fuel pressure. The fuel is provided to the fuel injector component at a second fuel rate, which is 20%-30% greater than the first fuel rate.

### RELATED APPLICATIONS

The present application is a Continuation-in-Part of U.S. Ser. No. 60/914,454 and it claims a priority to the provisional's Apr. 27, 2007 filing date. The present application incorporates the subject matter disclosed in ('454) as if it is fully rewritten herein.

### BACKGROUND OF THE INVENTION

1. Field of the Invention

The present invention relates to systems for the controlled combusting of fuels, and, more particularly, to internal combustion engine system fuel injector systems configured to operate on multiple types of fuel.

### SUMMARY OF THE INVENTION

In an internal combustion engine fuel is ignited and burned in a combustion chamber, wherein an exothermic reaction of the fuel with an oxidizer creates gases of high temperature and pressure. The pressure of the expanding gases directly act upon and cause a corresponding movement of pistons, rotors, or other elements, which are operationally engaged by a one or transmission systems to translate the element movement into working or motive forces.

The most common and important application of the internal combustion engine is the automobile, and due to its high energy density, relative availability and fully developed supply infrastructure, the most common fuels used in automobile engines in the United States of America and throughout the world are petroleum-based fuels, namely, gasoline and diesel fuel blends; however, a reliance upon petroleum-based fuels generates carbon dioxide, and the operation of millions of automobiles world-wide results in the release of a significant total amount of carbon dioxide into the atmosphere, wherein the scale of the amount generated is believed to contribute to global warning.

The petroleum acquisition and transportation operations associated with producing automotive fuels for the world also result in significant social and environmental impacts. For example, petroleum drilling and transportation discharges and by-products frequently cause significant harm to natural resources. The limited and unequal geographic distribution of significant sources of petroleum within a relatively small number of nations renders large consuming nations (such as the United States) net-importers dependent upon nations and sources outside of domestic political control, which has exasperated or directly resulted in international conflicts, social unrest and even warfare in many regions of the world.

One solution is to reduce the conventional automobile's reliance on petroleum-based fuel by substituting one or more economically and socially feasible alternative fuels, energy sources or motive energy systems. Many types of alternative fuels are available or have been proposed for use with internal combustion engines, including gasoline-type biofuels such as E85 (a blend of 15% gasoline and 85% ethanol) and P-series fuels, and diesel-type biofuels such as hempseed oil fuel or other vegetable oils. Alternative power systems (illustrative but not exhaustive examples include hydrogen combustion or fuel-cell systems, compressed or liquefied natural gas or propane gas systems, and electric motor systems) may also replace an internal combustion engine or be used in combination therewith in a “hybrid” system.

However, conventional internal combustion gasoline or diesel engines are designed to operate on fuel specifications that severely limit the possibilities of using alternative fuels. Since alternative fuel blends diverge greatly from conventional petroleum-based fuel specifications, merely substituting an alternative fuel typically results in poor performance of even in violations of governmental emissions requirements.

A long need is thus felt for a method or a system that addresses the problems discussed above. A need is felt for a system that enables a conventional automobile to efficiently use both conventional petroleum fuel blends and alternative fuels.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 illustrates a portion of a conventional PRIOR ART automobile fuel injector system;

FIG. 2 illustrates portions of an automobile fuel injector system in accordance with a preferred embodiment of the present invention; and,

FIG. 3 illustrates portions of another automobile fuel pump and injection system according to the present invention.

wherein the drawings are not necessarily to scale. The drawings are merely schematic representations not intended to portray specific parameters of the invention. The drawings are intended to depict only typical embodiments of the invention, and therefore they should not be considered as limiting the scope.

### DESCRIPTION OF THE PREFERRED EMBODIMENTS

### 1. Detailed Description of the Figures

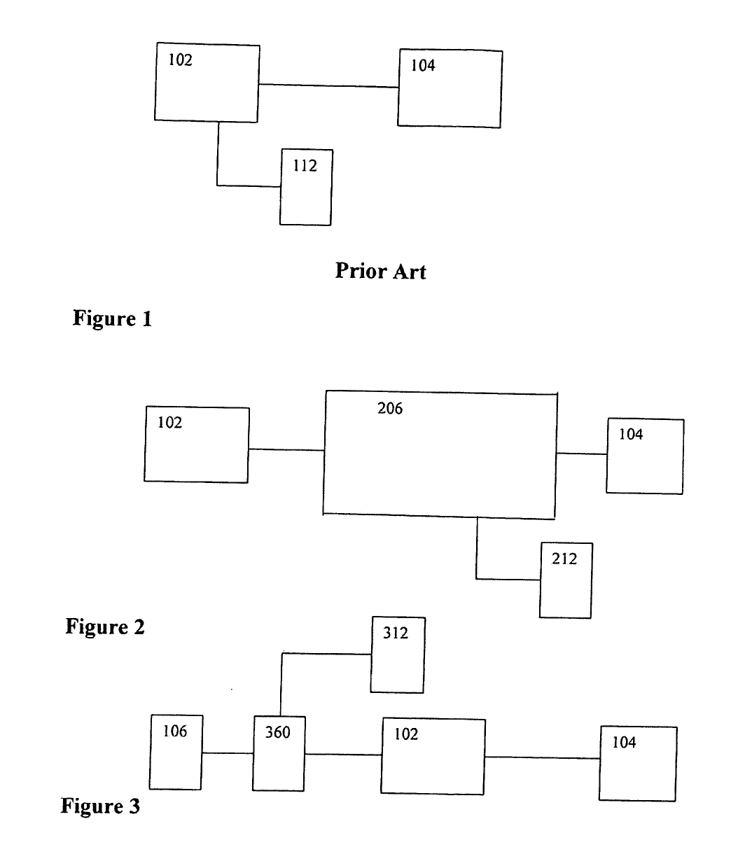

Referring now to FIG. 1, a gasoline internal combustion engine fuel pump 102 supplies pressurized fuel to a conventional automobile fuel injector component 104. In some engine systems, the fuel injector component 104 comprises a plurality of electronically controlled valves with at least one valve provided for each engine cylinder. The valves arc each supplied with pressurized fuel by a fuel pump (not shown). The valves are configured to open and close many times per second. With fuel pump 102 pressure held constant, the amount of fuel supplied to the engine is determined by the amount of time the fuel injector stays open. The length of time is called the “pulse width”. In other engine systems, the fuel injection component 104 comprises a single throttle body element 104, wherein one large diameter throttle body provides fuel to all of the engine cylinders.

The pulse width signals and fuel pump 102 fuel pressure determines the amount and rate of fuel injected into each engine combustion chamber, to thereby control the combustion chamber air-fuel ratio (AFR). The AFR is the mass ratio of air to fuel present during combustion. When all the fuel is combined with all the free oxygen within the combustion chamber, the mixture is chemically balanced and this AFR is called the stoichiometric mixture, which is ignited by the automobile ignition system in a timing coordination with cylinder head positioning and anticipated time of ignition and combustion. Each fuel has a preferred AFR or range of AFRs which will achieve optimal fuel combustion when ignited, and which is dependent in part on the amount of hydrogen and carbon found in a given amount of fuel. AFRs below preferred value(s) result in a rich mixture, wherein unburned fuel is left over after combustion and exhausted, wasting fuel and creating pollution. Alternatively, AFRs above preferred value(s) result in a lean mixture having excess oxygen, which tends to produce more nitrogen-oxide pollutants and can cause poor performance and even engine damage.

An engine control unit (ECU) (not shown) typically determines and provides pulse width signals to the fuel injection element 104 appropriate for engine operating conditions and dependent upon expected fuel pump 102 pressures and fuel characteristics. The ECU commonly receives AFR signals from an oxygen sensor located in a vehicle exhaust pipe to monitor the amount of oxygen in the exhaust and uses one or more formula(s) and a large number of lookup tables to determine an appropriate pulse width for a given operating condition, thereby avoiding too-rich and too-lean AFRs by increasing or decreasing fuel injector 104 pulse widths in real-time in a closed-loop control system. The ECU generally computes more than 100 parameters, each having its own lookup table. Some of the parameters even change over time in order to compensate for changes in the performance of engine components, s.a., e.g., a catalytic converter. Depending on the engine speed, the ECU performs these calculations over one hundred times per second.

Problems arise if these same pulse widths and fuel pump 102 pressures are used with alternative fuels. For example, E85 combustion generates lower energy as measured in British Thermal Units (BTUs) than gasoline fuel blends. More E85 fuel must be combusted to provide comparable petroleum fuel blend engine performances under similar operating parameters. One solution is to expand pulse widths, to thereby increase the amount of fuel provided to the fuel injection element 104; however, the computational demands on the ECU to provide multiple pulse width determinations for multiple fuels may exceed its computational capacity. A throttle body injection element 104 at full throttle is commonly open for 100% of a fuel supply period. It is therefore not possible to widen a pulse width or otherwise add more time to the period that the throttle body injector 104 is held open in order to allow more fuel to flow into the engine.

FIG. 2 provides an alternative fuel pump system according to the present invention, wherein a secondary fuel pump 206 is provided inline and interposed between the fuel pump 102 and the fuel injection component 104. When a conventional gasoline or diesel fuel blend is used, the secondary fuel pump 206 is inactive. The fuel pump 102 provides the fuel injection component 104 fuel pressures, e.g., pursuant to pulse width calculations by an ECU. When an alternative fuel is used with a lower BTU characteristic, the secondary fuel pump 206 is switched on for additional fuel pressure; more fuel is provided to the engine for the same pulse width or when a throttle body is at full throttle. In one embodiment configured for E85 alternative fuel use, the secondary fuel pump 206 adds about 27% more pressure; other embodiments may add between 20% to 30% more pressure.

The secondary fuel pump 206 may be programmed or otherwise configured by a manufacturer, an after-market retailer or installer, or by some other service provider. It may be subsequently reprogrammed, as required, to provide optimal fuel injector settings for one or more specified alternative fuels.

FIG. 3 illustrates another fuel pump and injection system according to the present invention, wherein a variable power element 360 is interposed between a conventional power supply 106 and a conventional fuel pump 102 to provide operational power to the conventional fuel pump 102. When an alternative fuel is used having a divergent BTU characteristic, the variable power element 360 increases or decreases power (e.g., volts or amps) otherwise supplied by the conventional power supply 106, thereby increasing or decreasing, respectively, fuel pump 102 pressure and the rate of fuel supply to the engine by the fuel injection component 104 when open. In one example configured for use with E85 fuel, the variable power element 360 is a voltage amplifier 306 configured to increase a conventional power supply 106 voltage or about 13.8 volts by from about 20% to about 30% and, more preferably, by about 27%.

The secondary fuel pump 206 and/or also covariable power element 360 are each further in communication with a switch 212 and/or 312, respectively, that toggle each of the secondary fuel pump 206 and/or variable power element 360 into active or inactive states. The switches 212, 312 thus enable use of a conventional fuel by placing the pump/element 206/360 into inactive states, as well as the use of at least one alternative fuel by switching each into an active state. The switch 214 may be manually operated by a user, or ti may be configured to detect a fuel type being used and automatically select between active and inactive states accordingly.

The foregoing descriptions of specific embodiments of the present invention are presented for purposes of illustration and description. They are not intended to be exhaustive nor to limit the invention to the precise forms disclosed and, obviously, many modifications and variations are possible in light of the above teaching. For example, alternative fuels practiced by the present invention are not limited to E85 fuels, and other alternative fuels may be practiced. Illustrative examples include P-series fuels, diesel-type biofuels such as hempseed oil fuel or other vegetable oils, liquified natural gas, hydrogen fuels, though others may be appropriate as understood by those in the art. Such modifications and variations that may be apparent to a person skilled in the art are intended to be included within the scope of the invention as defined by the accompanying claims.

Having thus described the invention what is claimed as new and desired to be secured by Letters Patent is as follows:

1. A system comprising:
a fuel pump configured to provide a fuel to a fuel injector component at a first fuel pressure, and thereby provide the fuel to the fuel injector component at a first fuel rate;
a pressure modifier connected to the fuel pump; and,
a switch in circuit communication with the pressure modifier;
wherein the pressure modifier is configured to increase or decrease the fuel pressure in response to an operation of the switch to provide the fuel to the fuel injector component at a second fuel pressure different from the first fuel pressure, thereby providing the fuel to the fuel injector component at a second fuel rate different from the first fuel rate.

2. The system of claim 1, wherein the pressure modifier is a secondary fuel pump interposed between the fuel pump and the injector component.

3. The system of claim 1, wherein the pressure modifier is a variable power element interposed between a power supply and the fuel pump.

4. The system of claim 2, wherein the first fuel pressure is less than the second fuel pressure and the first fuel rate is less than the second fuel rate.

5. The system of claim 3, wherein the first fuel pressure is less than the second fuel pressure and the first fuel rate is less than the second fuel rate.

6. The system of claim 4, wherein the second fuel rate is from about 20% to about 30% greater than the first fuel rate.

7. The system of claim 5, wherein the second fuel rate is from about 20% to about 30% greater than the first fuel rate.

8. The system of claim 6, wherein the second fuel rate is about 27% greater than the first fuel rate.

9. The system of claim 7, wherein the second fuel rate is about 27% greater than the first fuel rate.

10. A method, comprising the steps of:
modifying a fuel pressure supplied to a fuel injector component by a fuel pump; and,
increasing or decreasing a rate of supply of a fuel by the fuel injector component to an engine combustion chamber in response to the step of modifying the fuel pressure.

11. The method of claim 10, wherein the step of modifying the fuel pressure comprises the steps of:
interposing a secondary fuel pump between the fuel pump and the fuel injector component;
switching the secondary fuel pump on; and,
increasing or decreasing the fuel pump fuel pressure by means of the secondary fuel pump.

12. The method of claim 10, wherein the step of modifying the fuel pressure comprises the steps of:
interposing a variable power element between a power supply and the fuel pump;
switching the variable power element on; and,
increasing or decreasing the power supplied to the fuel pump by the power supply, the variable power element increases or decreases the power supplied; and,
increasing or decreasing the fuel pressure in response to the step of increasing or decreasing the power supplied by the fuel pump.

13. The method of claim 11, wherein the fuel pump increases or decreases the fuel pressure, the step of the fuel pump increasing or decreasing the fuel pressure comprises increasing the fuel pressure, the step of the fuel injector component increasing or decreasing the rate of supply of the fuel comprises increasing the rate of supply.

14. The method of claim 1, wherein the fuel pump increases or decreases the fuel pressure, the step of the fuel pump increasing or decreasing the fuel pressure comprises increasing the fuel pressure, the step of the fuel injector component increasing or decreasing the rate of supply of the fuel comprises increasing the rate of supply.

15. The method of claim 13, wherein the step of increasing the rate of supply comprises increasing the rate of supply from about 20% to about 30%.

16. The method of claim 14, wherein the step of increasing the rate of supply comprises increasing the rate of supply from about 20% to about 30%.

17. The method of claim 15, wherein the step of increasing the rate of supply comprises increasing the rate of supply from about 27%.

18. The method of claim 16, wherein the step of increasing the rate of supply comprises
increasing the rate of supply from about 27%.
